(19) United States
(12) Patent Application Publication
(10) Pub. No.: US 2007/0172304 A1
(43) Pub. Date: Jul. 26, 2007

(54) Package for merchandising consumer care products

(76) Inventors: Michael John Bolander, Loveland, OH (US); Su-Yon McConville, Mason, OH (US); Christopher Luke Leonard, Mason, OH (US); Theresa Louise Johnson, South Lebanon, OH (US); Charlene Marie Stevenot, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/599,105

(22) Filed: Nov. 14, 2006

Related U.S. Application Data
(63) Continuation-in-part of application No. 11/515,550, filed on Sep. 5, 2006, now abandoned.
Application No. 11/515,550 is a continuation-in-part of application No. 11/274,870, filed on Nov. 15, 2005.

(51) Int. Cl. B43K 7/06

(52) U.S. Cl. 401/194

(57) ABSTRACT

A consumer care product comprising packaging that contains the consumer care product during use of the consumer care product, the packaging comprising an outer surface and a consumer care product identifier that is visibly detectable as viewed from outside the packaging, wherein the identifier is disposed radially inward from the outer surface; and a consumer care composition disposed in the product chamber.

### CROSS REFERENCE TO RELATED APPLICATION

This application is a continuation-in-part of U.S. application Ser. No 11/515,550, filed on Sep. 5, 2006, which is a continuation-in-part of U.S. application Ser. No. 11/274,870, filed on Nov. 15, 2005.

### FIELD OF THE INVENTION

The present invention relates to packages for merchandising consumer care products and methods of merchandising the same. The packages are particularly suited for antiperspirant and/or deodorant products, but can equally be employed for other types of consumer care products.

### BACKGROUND OF THE INVENTION

Traditionally, consumer care products such as antiperspirants and/or deodorant products are packaged in an oval or round plastic barrel component. The top of the barrel is open to allow the product to be exposed and dispensed for use, while the opposite, i.e. bottom, end of the barrel contains a mechanism (e.g., a product support elevator coupled with a hand-rotatable screw) to assist in the dispensing of the product. In dual chamber dispensers, as disclosed in U.S. Pat. No. 6,817,799, issued to Petit, the shape of the outer chamber may generally conform to the shape of the inner chamber which may limit the functional and/or aesthetic appeal of the container. Even in dual chamber dispensers wherein the shape of the outer chamber varies from the shape of the inner chamber, as disclosed in U.S. Pat. No. 6,592,278, issued to Holthaus, the outer chamber shape is not so distinctly and purposely designed so as to communicate product traits to a consumer.

Antiperspirants and/or deodorant products may also be found on store shelves with a pressure sensitive label. Often, there is a very subtle distinction between one product and the next. Customers are unable to distinguish product form or benefits from market shelf appearance. Even within the same brand, particularly, the same sub line, consumers are not able to readily identify performance characteristics associated with a particular product. Furthermore, as brands of antiperspirants and deodorants broaden with various forms and scents, manufacturing of labels or other product identifiers can become costly. Thus, a need exists for a well-differentiated line of antiperspirant products that aid a consumer in readily selecting the desired product form, scent, level of antiperspirant efficacy or other distinct product benefit while alleviating manufacturing costs.

### SUMMARY OF THE INVENTION

The present invention is directed to consumer care products. In accordance with one of the preferred embodiments, there has now been provided a consumer care product comprising packaging that includes a product chamber at least partially surrounding the consumer care product; an outer jacket that is semi-permanently or permanently engaged with the product chamber; and a consumer care composition disposed in the product chamber. The outer jacket includes a jacket outer surface and a visibly detectable product identifier, wherein at least a portion of the identifier is not associated with the jacket outer surface.

In accordance with another preferred embodiment, there has now been provided a consumer care product comprising packaging and a consumer care composition disposed in the packaging. The packaging comprises an outer surface and a consumer care product identifier that is visibly detectable as viewed from outside the packaging, wherein the identifier is disposed radially inward from the outer surface.

In accordance with yet another preferred embodiment, there has now been provided a consumer care product comprising packaging including a product chamber at least partially surrounding the consumer care product; an outer jacket that is semi-permanently or permanently engaged with the product chamber; and a consumer care composition disposed in the product chamber. The product chamber comprises a color and/or identifier associated with the brand of the consumer care product that is visibly discernable when viewing the packaging from the outside.

The present invention is also directed to various arrays of products from which a consumer may pick a particular consumer care product suited for their need. The arrays of products are defined by various combinations and permutations of packaging components described herein. In accordance with one of the preferred embodiments, there has now been provided an array of consumer care products comprising: a) a first consumer care product including a first brand and packaging comprising a first product chamber at least partially surrounding the first consumer care product, and a first outer jacket that is semi-permanently or permanently engaged with the first product chamber; and b) a second consumer care product including the first brand and packaging comprising a second product chamber at least partially surrounding the second consumer product, and a second outer jacket that is semi-permanently or permanently engaged with the second product chamber. The first and second product chambers are visually distinct from one another and/or the first and second outer jackets are visually distinct from one another.

In accordance with another preferred embodiment, there has now been provided an array of consumer care products comprising a) a first consumer care product including a first brand and packaging comprising a first product chamber at least partially surrounding the first consumer care product, and a first outer jacket that is semi-permanently or permanently engaged with the first product chamber; and b) a second consumer care product including the first brand and packaging comprising a second product chamber at least partially surrounding the second consumer product, and a second outer jacket that is semi-permanently or permanently engaged with the second product chamber. The first and second outer jackets are shaped differently from one another.

In accordance with yet another preferred embodiment, there has now been provided an array of consumer care products comprising a) a first sub line of consumer care products comprising a first packaging system and a first composition disposed therein, and a second packaging system and a second composition disposed therein, the second composition being different from the first composition, wherein each of the first and second packaging systems comprises a product chamber and an jacket semi-permanently or permanently engaged with the product chamber; and b) a second sub line of consumer care products comprising a third packaging system and a third composition disposed therein, and a fourth packaging system and a fourth composition disposed therein, the fourth composition being different from the third composition. Each of the third and fourth packaging systems comprises a product chamber and an outer jacket semi-permanently or permanently engaged with the product chamber. And at least one of the first, second, third and fourth packaging systems are visually distinct from another of the first, second, third and fourth packaging systems.

In accordance with another preferred embodiment, there has now been provided an array of consumer care products comprising a) a first consumer care product including a first brand and a first packaging system comprising a first product chamber at least partially surrounding the first consumer care product; a first outer jacket semi-permanently or permanently engaged with the first product chamber, the first outer jacket comprising a first outer surface; and a first identifier that is disposed radially inward from the first outer surface; and b) a second consumer care product including the first brand and a second packaging system comprising a second product chamber at least partially surrounding the second consumer product; a second outer jacket semi-permanently or permanently engaged with the second product chamber, the second a second outer surface, and a second identifier that is disposed radially inward from the second outer surface. The first identifier and the second identifier are different from one another.

The present invention is further directed to packaging systems for use with consumer care products. The packaging systems employ two or more different materials, such as, for example, a first material comprising recycle plastics and a second material comprising virgin or non-recycled plastics. In accordance with one of the preferred embodiments, there has now been provide a packaging system comprising a product chamber configured for at least partially surrounding a consumer care product, and an outer jacket that is semi-permanently or permanently engaged with the product chamber, wherein the product chamber comprises a first material, and wherein at least a portion of the outer jacket comprises a second material that is different from the first material.

### BRIEF DESCRIPTION OF THE DRAWINGS

While the specification concludes with claims that particularly point out and distinctly claim the invention, it is believed that the present invention will be better understood from the following description of embodiments, taken in conjunction with the accompanying drawings in which:

FIG. 1 is a front perspective view of one embodiment of the present invention not including the cap comprising a product chamber comprising an applicator surface and an outer jacket comprising an identifier;

FIG. 2 is a cross-sectional top perspective view of one embodiment of the present invention not including the cap comprising a product chamber comprising an identifier and applicator surface and an outer jacket;

FIG. 3 is a bottom perspective view of a cap of the present invention;

FIG. 4A is a front view of a sub line of products comprising a cap and product chamber-only embodiment of the present invention;

FIG. 4B is a front view of multiple sub lines of products that include visual distinctions between product chambers, outer jackets and/or identifiers associated therewith;

FIG. 5 is a front perspective view of one embodiment of the present invention not including the cap comprising a product chamber comprising an applicator surface and an identifier; a sleeve comprising an identifier; and an outer surface;

FIG. 6 is a front perspective view of an outer jacket of the present invention not including the cap;

FIG. 7 is a front cross-sectional view of one embodiment of the present invention including the cap comprising a product chamber; an outer jacket and a dispensing means;

FIG. 8 is a front view of one embodiment of the present invention including a product comprising a product chamber, and an outer jacket comprising an identifier;

FIG. 9 is a front view of one embodiment of the present invention comprising a product chamber comprising an identifier and an outer jacket comprising an identifier

FIGS. 10-13 are front views of various embodiments of the present invention.

### DETAILED DESCRIPTION OF THE INVENTION

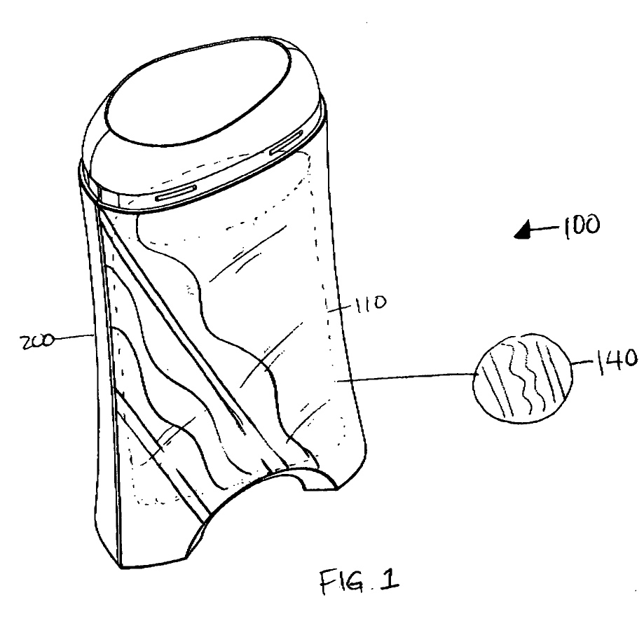

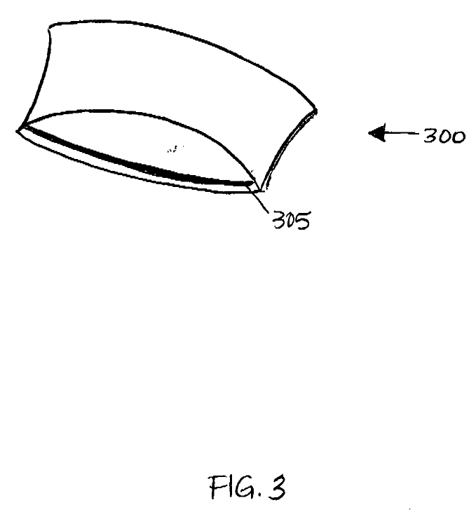

The present invention relates to a consumer care product, particularly beauty care products, wherein the package enclosing such product comprises distinguishing aesthetic features to aid a consumer in selecting their desired product. For example, FIG. 1 shows generally one embodiment wherein the package 100 of the present invention may comprise at least one product chamber 110 and an outer jacket 200 for dispensing a consumer care product (not shown), wherein an identifier 140 may be included on the product chamber 110, the outer jacket 200 or both. Identifier 140 may be associated with the inner surfaces and/or outer surfaces of product chamber 110 and outer jacket 200, and may alternatively reside in an area between the product chamber and outer jacket. The present invention may also include a cap 300 (FIG. 3) as part of the overall package, wherein the cap 300 (FIG. 3) may coordinate with the aesthetics of the package 100.

Another embodiment may include only a product chamber package for a consumer care product comprising a cast/shape identifier that aids a consumer in distinguishing a desired product within a sub line of branded consumer care products. While products currently on the market may vary in shape and/or size, usually the shape/size is substantially the same amongst products within the same sub line. Without a true differentiation between products, consumers may be left confused and unable to readily identify and select their desired products without reading the label. The present invention alleviates the need to read labels by readily identifiable packages that are distinctly designed to aid a consumer in selection of their desired product.

With various products on store shelves, consumers are faced with difficulties in selecting the appropriate or desired product. Similarity in packages leave consumers bound to select the wrong product which may lead to buyer's remorse or time wasted returning to stores for the exchange of products. Overall, the present invention provides for a package that aids a consumer to readily select their desired product, convey performance or product benefits, and better aid a consumer in identifying their desired product. The present invention also provides enhanced shelf appearance of consumer care products with particularly designed aesthetic features to present an improved distinction of brand within a sub line or from competition. The present invention may also minimize manufacturing costs often associated with marketing various consumer care products.

Due to such novel characteristics as described herein, the present invention may also provide various methods of merchandising a consumer care product, methods of promoting consumer care products, methods of advertising and methods of generating advertising revenue utilizing the packages described herein.

While the specification concludes with the claims particularly pointing and distinctly claiming the invention, it is believed that the present invention will be better understood from the following description.

“Consumer care product”, as used herein, also referred to as the “product”, refers to any consumer care product including but not limited to beauty care products, household care products, health care products, pet care products and the like.

“Antiperspirants”, as used herein, includes antiperspirants, deodorants, deodorant/antiperspirants and body sprays, and may also be considered as beauty care products.

As used herein, “transparent” or “visibly clear” is defined as having the property of transmitting light without appreciable scattering so that bodies lying behind are perceivable. One acceptable test method for determining whether a product is clear is to attempt to read a series of words placed immediately behind and contacting one surface of the package, the words being printed in black color, 14 point Times New Roman font, printed on a white sheet of paper. The word and/or letters must be visible and/or readable from the front of the package by an individual using unaided 20/20 eyesight and positioned 12 inches in front of the package in indoor lighting conditions, such as retail outlet lighting conditions.

The term “translucent”, as used herein may include “frosted”, “glittered”, “pearlescence” and the like and is defined herein as the practice of inducing a low level of light scattering into an otherwise “clear” material causing the material to become matted in appearance.

As used herein, “substantially opaque” refers to the ability to sufficiently block the transmission of light so that bodies lying behind are not easily perceivable. Substantially opaque includes “tinted” and is defined herein as the practice of adding a low level of pigment of dye into a material for the purpose of imparting a color into the material.

As used herein, “inner sleeve” refers to an additional layer that may be included in the package outside of the outer surface of the product chamber but within the inner area of the walls of the outer jacket. The inner sleeve is distinguishable from the “product chamber” that surrounds the product and the “outer jacket” that is the last outer layer of the package. The inner sleeve may be defined by a plurality of discrete elements that can be connected or separate from each other. The inner sleeve may or may not be coextensive with the product chamber or outer jacket. The inner sleeve may be engaged with the product chamber and/or outer jacket, and may also be simply contained therebetween. The inner sleeve may be an optional component of the package of the present invention and does not come into contact with the product.

As used herein, “identifier” relates to a means for communicating between the consumer and the consumer care product such that the consumer may readily identify the consumer care product and its associated traits, including, but not limited to product form, product performance, scents and the like. Identifiers of the present invention may include, but are not limited to, pressure sensitive labels; shrink wrap labels; indicia; colors or other visually detectable or discernable aspects (e.g., “sparkles” or “glitter” via incorporation of interference pigments) that are part of the material from which the packaging components are made or that is subsequently added to the manufactured components; defined relief, indentation, windows and/or voids formed in the components during or after their manufacture; cast designs, including but not limited to novelty casting to identify characters, paraphernalia, animals, and the like; particular shapes or other means of decoration and/or information sharing used to identify and distinguish the product. The identifiers may be formed concurrently with the manufacture of the components with which their associated, may be introduced during the manufacture of the components, and/or may be formed or applied to the components after the components are manufactured. The identifiers of the present invention may be the same or different from one another.

As used herein, “novelty cast” may include, but is not limited to, casts/shapes that replicate cars, sport balls, animals or people figures, characters, logos, sport paraphernalia (e.g., helmets, bats, jerseys, shoes and the like), fashion accessories and the like.

As used herein, “engaged” refers to the means by which the product chamber and the outer jacket (and possibly inner sleeves, if present) of the present invention are in contact with each other. Engaged includes direct or indirect contact, permanent, semi-permanent, or temporary contact (such as, for example, being removable).

The terms “semi-permanent” and “permanent” are used herein to describe the nature of how packaging components are engaged with one another. Components that are semi-permanently or permanently engaged with one another are intended to remain with a consumer care product when it is being used. That is, the packaging components are not intended to be removed and discarded prior to using the accompanying consumer care product. Semi-permanent engagement means that the components are designed and configured to permit disengagement, while permanent engagement means that the components are designed and configured to remain connected but could become unconnected through force and/or by destroying or disfiguring the components.

It is understood that the “package” of the present invention may include a cap that may be a part of the overall aesthetics of the package or may coordinate with the various components of the package to aid a consumer in selecting their desired product.

Product Chamber

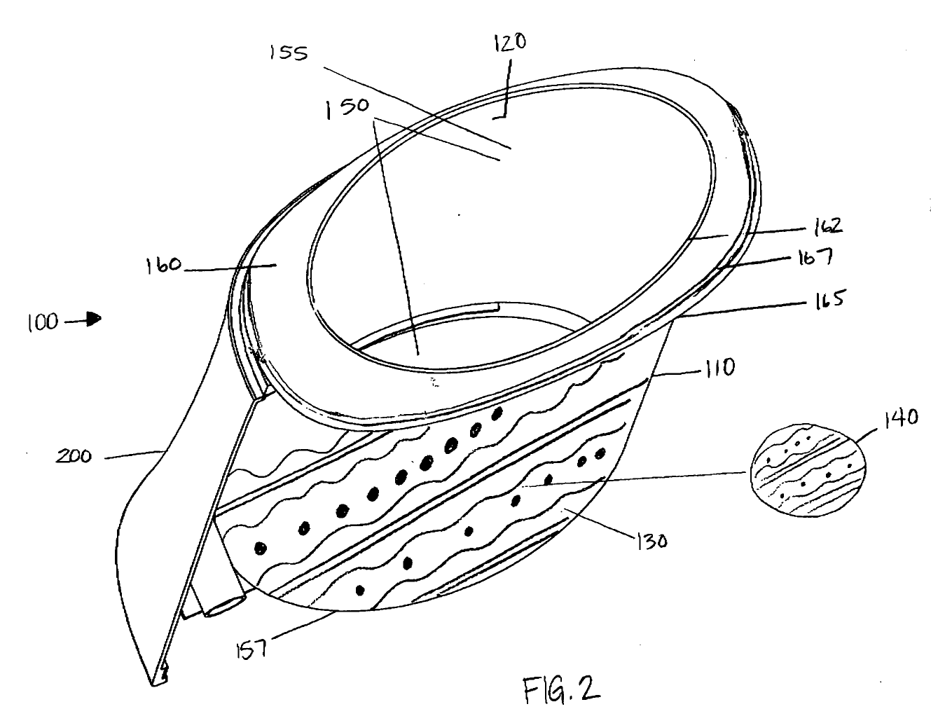

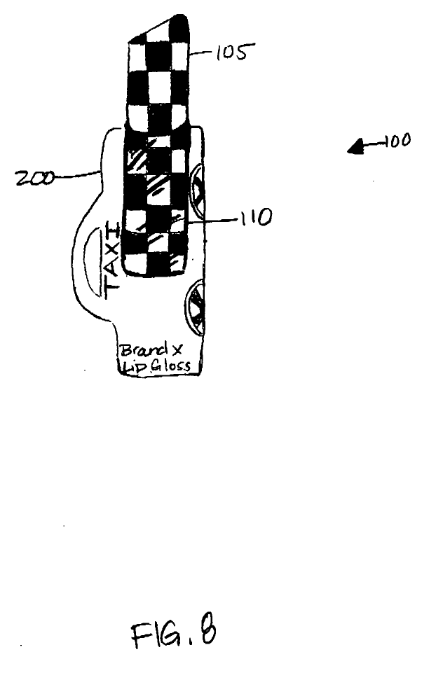

As shown generally in FIGS. 1 and 2, an exemplary package 100 includes at least one product chamber 110 comprising at least one lateral wall having an inner surface 120 that at least partially surrounds and supports a consumer care product 105 (FIG. 8) and an outer surface 130. The product chamber 110 may comprise an identifier 140 wherein the identifier 140 may be, for example, a nondescript shape, a novelty cast, a particular shape including, but not limited to, circle, square, rectangle, oval, star, heart, diamond, polygons and the like, or a shape of the product. The consumer care product 105 (FIG. 8) may be in the form of a solid, semi-solid, liquid, gel, mousse or the like. Held within the surrounding walls, particularly the inner surface 120 of the product chamber 110, the product 105 (FIG. 8) may be dispensed from at least one opening 150 of the product chamber 110 located at the top 155 and/or bottom 157 of the chamber 110. For example, the product chamber 110 may comprise a top opening 155 wherein the top opening 155 may comprise an upwardly facing applicator surface 160 that is integrally formed with the product chamber 110. The applicator surface 160 may also be a separate member that is attached to the product chamber 110. The applicator surface 160 may extend outwardly from and completely around the periphery of the top opening 155. The applicator surface 160 about the top opening 155 may comprise a curvature including, but not limited to, convex, concave or a mixture thereof as seen in cross section, in the direction of the top 155 of the product chamber 110. The applicator surface 160 also has a top edge 162, closest to the top opening 155 of the product chamber 110 and a skirt 165 (i.e., bottom edge), furthest from the top opening 155 of the product chamber 110 and provides a surface for applying the product 105 (FIG. 8). When the product chamber 110 is held vertically, with the opening at the top, the skirt 165 of the applicator surface 160 is below the level of the top edge 162 (with respect to the top of the product chamber) and adjacent the product chamber 110. The applicator surface 160 about the periphery of the product 105 (FIG. 8) aids in applying and rubbing in the desired amount of product 105 (FIG. 8) and may be smooth or textured. Textured applicator surfaces include, but are not limited to dimpling, bumping, electrical discharge machining (EDM), coating, emboss, deboss or mixtures thereof. The skirt 165 of the applicator surface 160 may comprise at least one groove 167 or any other conventional means for engaging the product chamber 110 via direct contact with the outer jacket 200 and/or the cap 300 (FIG. 3) of the present invention.

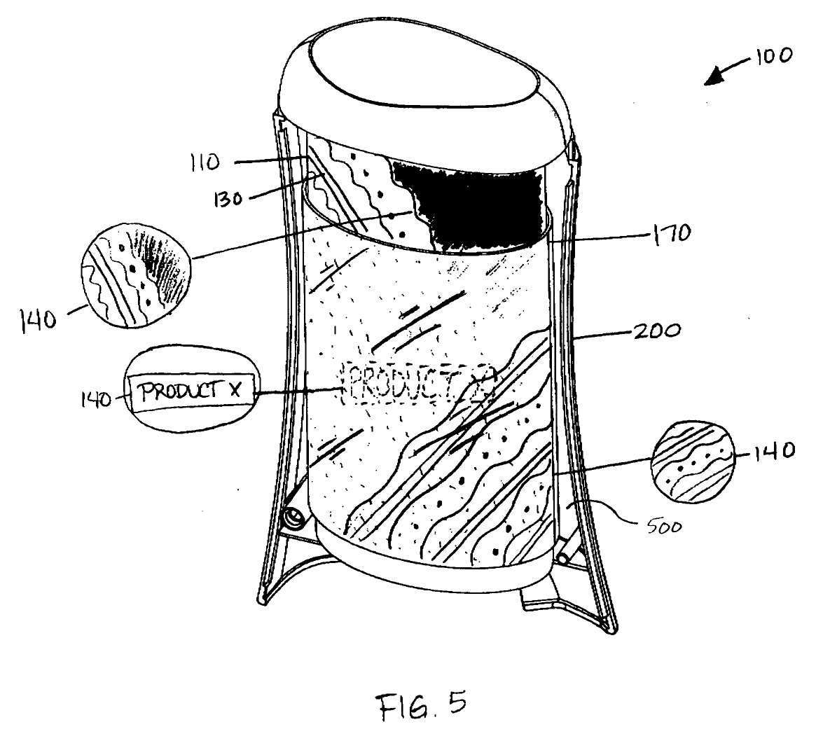

Referring generally to FIG. 3, the cap 300 may also comprise at least one rib 305 or any other conventional means for engaging via direct contact with the groove 167 (FIG. 2) in the skirt 165 (FIG. 2). The cap 300 of the present invention may also comprise an identifier 140 (FIG. 2) wherein the cap 300 may coordinate with the product chamber 110 (FIG. 2), the outer jacket 200 (FIG. 2), the inner sleeve 170 (FIG. 5) or combinations thereof that communicates with a consumer and readily identifies their desired product.

The present invention provides for identifiers 140 associated with package 100 to aid the consumer in readily selecting a consumer care product. The outer surface 130 (and/or inner surface) of the product chamber 110 may provide a visually appealing identifier 140 that contributes to the particular design features of the invention and aids a consumer in selecting a desired product. For example, the outer surface 130 (and optionally the entire wall) of the product chamber 110 may have a visual appearance that is transparent, translucent or substantially opaque, or include a portion of the same. The outer surface 130 (and/or inner surface) of the product chamber 110 may also comprise an identifier 140 that communicates to the consumer and aids in selection of the product.

When the product chamber is at least partially transparent or translucent, an identifier may be defined by the consumer product 105 itself (e.g., includes visually detectable beads, pigments (see formulation Example 1 below), color contrasted phases or designs, such as, for example, sparkles, swirls and stripes), or may be defined by a combination of the consumer product 105 and the product chamber (including aspects attached or engaged therewith). In addition, the identifier can be included within the wall of the product chamber where the product chamber includes at least a portion proximate the identifier that is transparent or translucent. For example, the identifier could be in the form of a label that is disposed between two wall portions that are either independently manufactured and assembled or that are created through in-mold labeling techniques. In an alternate embodiment, the identifier may be defined by an indentation or relief that is formed in the product chamber during or after its manufacture. Inwardly disposed surfaces of such indentation or relief may comprise a label or color that contrasts its surroundings to highlight the identifier. The identifier 140 of the product chamber 110 may be the same or different from that of an identifier 140 associated with the outer jacket 200.

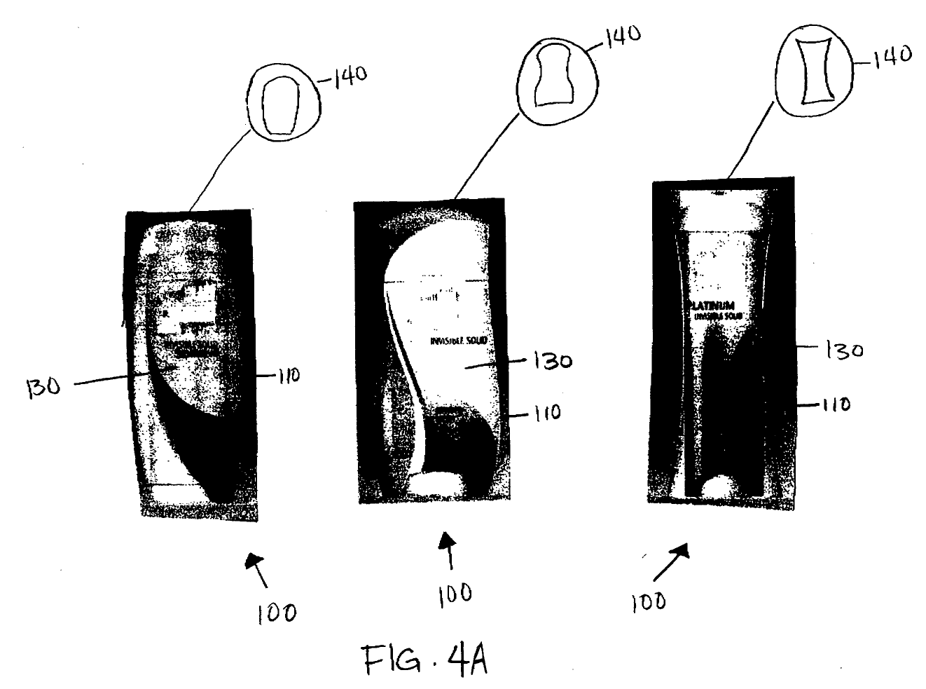

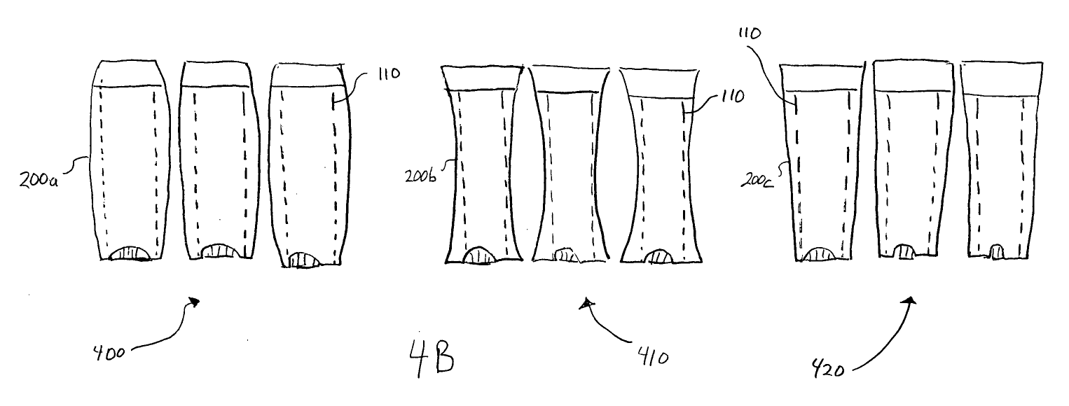

The product chamber 110 of the present invention may be used alone, in combination with an outer jacket 200 or in combination with one or more sleeves 170 (FIG. 5) and an outer jacket 200 (FIG. 5) as described herein. Referring generally to FIG. 4A, a product chamber 110 may be used alone as the overall package wherein the outer surface 130 can provide at least one aesthetically-pleasing identifier 140 sought by a consumer to readily select their desired product. For example, a product-chamber-only 110 package may communicate product performance to distinguish products within a brand's sub line. By “brand sub line” it is meant a line of products that are targeted to a particular consumer sub-group, provides a real or perceived distinctive benefit, and/or manifests a real or perceived distinctive attribute. By way of example, a consumer care product may be an antiperspirant/deodorant product with the sub lines including, a sensitive skin line, a botanical line, a high performance/high efficacy line, and a no fragrance line. Another example of sub lines may include a “treatment” line that comprises treatments to address extreme personal care conditions (e.g., malodor, excessive perspiration (hyperhidrosis), excessive dandruff, excessive dryness or oiliness), a “high performance” line that targets superior performance as compared to other offered products, an “essentials” line that provides value-added, trusted or reliable performance, and an “expressives” line that provides sensorial experiences with reliable performance. There may be a single product form or multiple product forms within a given sub line. For example, antiperspirant and deodorant products can come in a variety of forms, including solids, soft solids, gels, and roll-ons. Various sub lines may include the same or different product forms and may include the same number or a different number of product forms. Without being bound by theory, one embodiment of the present invention may be employed utilizing, for instance, three varying cast/shape-identifiers on three separate product-chamber-only 110 packages to distinguish between product performances across sub lines and communicate to the consumer high, normal and sensitive efficacy levels as shown in FIG. 4A. Because of the purposely distinct shapes alone or in combination with another identifier, the present invention readily aids a consumer in selecting between various sub lines. Each product-chamber-only 110 package is readily distinguishable at shelf and readily identifies product performance without necessitating a consumer to read the label. Currently, there are no marketed products that so readily aid a consumer in making such a selection amongst the same brand, sub line or even more so, amongst competition. The product-chamber-only 110 package of the present invention alleviates such shortcoming.

Referring now to FIG. 4B, multiple product sub lines are shown, comprising a first sub line 400 of consumer care products, a second sub line 410 of consumer care products, and a third sub line 420 of consumer care products. The product chambers 110 associated with each of the products is the same. However, the outer jackets 200a associated with first sub line 400, outer jackets 200b associated with second sub line 410, and outer jackets 200c associated with third sub line 420 have a different shape (geometry) from one another. In alternative embodiments (not shown), the product chambers across the different sub lines could be visually distinct from one another, with visually similar or different outer jackets. Each of the product sub lines comprises three scent versions that may have a correspondingly distinct product identifier.

As shown generally in FIG. 5, an inner sleeve 170 or inner sleeves may also be used to create a more varied and visually-pleasing layered package. For example, a multi-layered package may comprise identifiers 140 that create three-dimensional or multi-dimensional effects. The result is a multi-layer package whereby the identifier 140 of the outer surface 130 of (or otherwise associated with) the product chamber 110 may coordinate with the identifier 140 of the sleeve 170 and the identifier 140 of the outer jacket 200 to present an improved distinction of brand from competition, convey performance or product benefits, and better aid a consumer in identifying their desired product. The inner sleeve 170 may be a nondescript shape, a novelty cast, a particular shape including, but not limited to, circle, square, rectangle, oval, star, heart, diamond, polygons and the like, or may take on the shape of the product chamber 110 and/or the outer jacket 200.

Although the inner sleeve in FIG. 5 is illustrated as a lengthwise structural element, it may alternatively be defined by a plurality of distinct elements that may or may not be connected to one another. The inner sleeve may be positioned in a number of varying positions along the length of the product chamber or outer jacket, may extend to various amounts relative to the product chamber or outer jacket, and may or may not be connected with the product chamber or outer jacket.

Outer Jacket

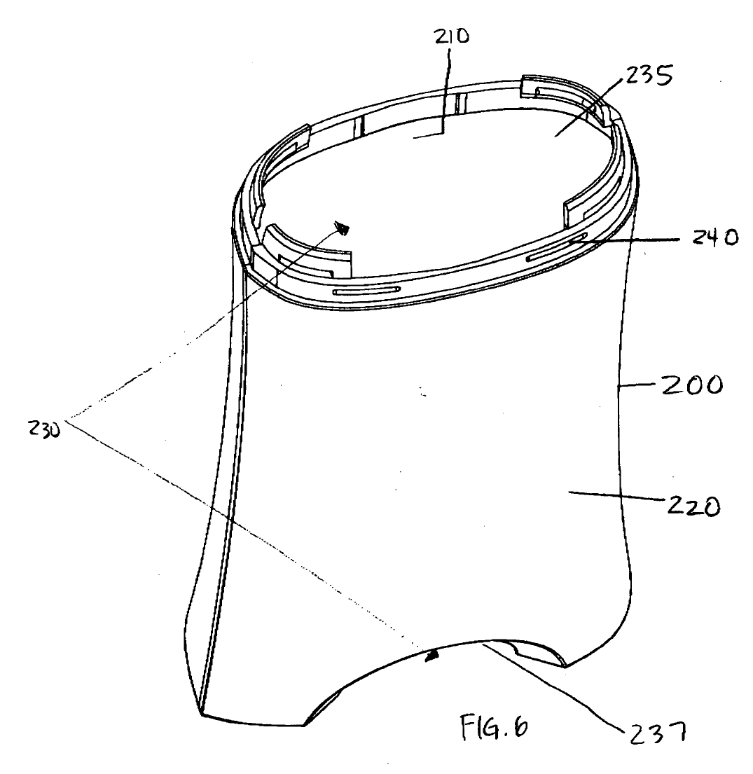

Referring generally to FIG. 6, exemplary package 100 (FIG. 5) of the present invention may also include an outer jacket 200 that contributes to a multi-layer package that aids a consumer in selecting their desired product. The outer jacket 200 comprises at least one lateral wall having an inner area 210 at least partially surrounding the product chamber 110 (FIG. 5) and an outer area 220 that aids in communicating product traits to the consumer. Preferably, the cross-section of the outer jacket 200 is larger than the cross-section of the product chamber 110 (FIG. 5) (when viewed in the direction of the top of the outer jacket and product chamber). The outer jacket 200 may comprise an identifier 140 wherein the identifier 140 (FIG. 5) may be a nondescript shape, a novelty cast, a particular shape including, but not limited to, circle, square, rectangle, oval, star, heart, diamond, polygons and the like, or a shape of the product chamber 110 (FIG. 5). The outer jacket 200 comprises at least one opening 230 at the top 235 and/or bottom 237 of the outer jacket 200 to allow the product 105 (FIG. 8) to be dispensed via the product chamber 110 and out of the outer jacket 200. The inner area 210 of the outer jacket 200 may comprise at least one snap bead 240 or other conventional means to directly contact the engagement means such as the groove 167 (FIG. 2) in the skirt 165 (FIG. 2) of the product chamber 110 (FIG. 2) in order to keep the product chamber 110 (FIG. 2) engaged with the outer jacket 200. Referring back to FIG.2, the outer jacket may also comprise an applicator surface (not shown) similar to that of the product chamber 110. Thus, the outer jacket 200 may comprise an applicator surface (not shown) that adds to the applicator surface 160 of the product chamber 110 for a combined, wider applicator surface. The product chamber 110 (FIG. 5) may also be absent an applicator surface 160 such that the package 100 relies only on the applicator surface (not shown) of the outer jacket 200.

Referring back to FIG. 5, while the outer surface 130 of the product chamber 110 may comprise an identifier 140 that communicates to a consumer, the outer area 220 (FIG. 6) of the outer jacket 200 may also comprise a visually appealing identifier 140 that adds to the design features of the invention. For example, the identifier 140 of the outer jacket 200 may communicate with the identifier 140 of the product chamber 110 as part of a multi-layer package design that aids a consumer in the selection of a product. By utilizing a multi-layer design approach, the present invention is able to provide a more distinctive appearance, such as three-dimensional appearance at shelf. Additionally, because it is the most outer portion of the multi-layer package, the identifier 140 of the outer jacket 200 can be more dramatic and visual to the consumer. For example, the outer jacket 200 can be distinctly molded and casted as a novelty or promotional tool that directly communicates to the consumer for advanced marketing. Without being limited by theory, such novelty casting may include, but is not limited to, cars, sports balls, animal or people figures, sports paraphernalia (e.g., helmets, bats, jerseys, shoes and the like), fashion accessories and the like. See, for example, FIGS. 8 and 10-13. An identifier associated with the outer jacket may alternatively be located in or on other portions of the outer jacket instead of the outer jacket's outer surface—for example, an inner surface of the outer jacket.

The outer area 220 (FIG. 6) of the outer jacket 200 may be transparent, translucent, substantially opaque or combinations thereof. Thus, the present invention results in an innovative multi-layer package whereby the aesthetics of the package 100 present an improved distinction of brand from competition, convey performance or product benefits, and better aid a consumer in readily identifying their desired product. In embodiments wherein the outer jacket is either partially or completely transparent or translucent, identifiers that are positioned at some location radially inward from the package's outermost surface accordingly are visible and available for consumers to consider when making purchasing decisions. Other techniques for making such inwardly-disposed identifiers visible are contemplated by the present invention. For example, the outer jacket may contain indentations, “windows” or voids (not shown) through which a radially inwardly disposed identifier can be viewed. Such windows or voids themselves may be uniquely shaped to define an identifier that can visually complement a second inwardly disposed identifier. Also, the outer jacket may not be coextensive with the product chamber, such that a portion of the product chamber is exposed. This exposed portion of the product chamber may contain an identifier or part of an identifier. In some embodiments, the identifiers of the present invention may comprise a first portion that is disposed on the outermost surface of the package (e.g., the outer surface of the outer jacket) and a second portion that is disposed radially inward from this outermost surface.

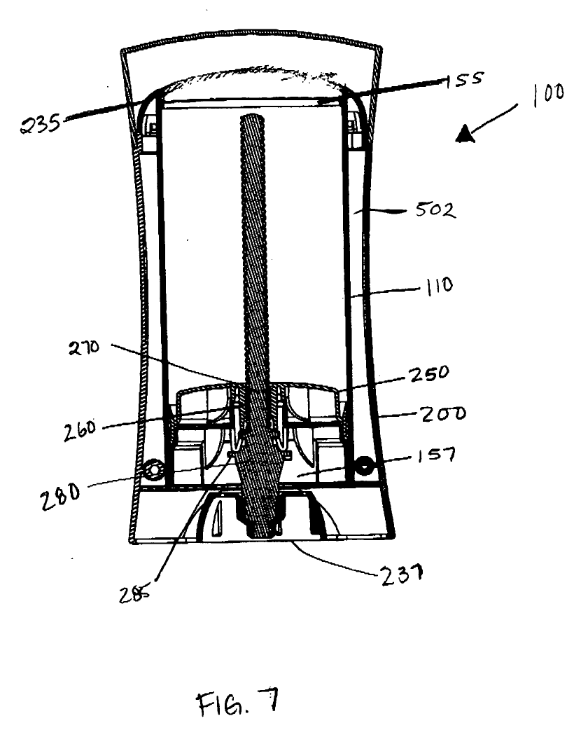

Referring generally to FIG. 7, the means for dispensing the product 105 (FIG. 8) from the package 100 of the present invention can be any conventional means known in the art for moving the product up or down within the package relative to the product chamber 110. For example, the bottom opening 237 of the outer jacket 200 and the bottom opening 157 of the product chamber 110 may be open to contain the mechanisms for dispensing the product 105 (FIG. 8) through the top opening 155 of the product chamber 110 and top opening 235 of the outer jacket 200. For example, a movable support member 250 may be used wherein the central portion of the movable support member 250 is provided with a threaded coupling sleeve 260 for cooperation with an elevator screw 270. The lower end of the elevator screw 270 may be axially fixed but rotatable within an opening in the bottom end of the product chamber 110 and outer jacket 200. The elevator screw 270 may include a tapered section 280 which can be snap fitted using resilient tabs 285 in the bottom opening 157 of the product chamber 110 to retain the elevator screw 270 in the position shown while permitting the screw 270 to be rotated by means, including but not limited to knobs, ratchets, wheels, levers, triggers and the like provided on the lower end of the screw. Rotation of the knob permits the user to raise or lower the movable support member 250 relative to the product chamber 110 thereby raising and lowering the product relative to the product chamber 110. In addition to screws and threads, clicker devices (not shown) may also be employed as a means of moving the product 105 (FIG. 8) up and down within the product chamber 110. Such mechanisms may be used as disclosed in U.S. Pat. No. 6,592,278, issued to Holthaus on Jul. 15, 2003 and assigned to Kommanditgesellschaft auf Aktien.

Referring again to FIG. 2, in addition to providing a consumer-noticeable, aesthetically-pleasing, readily-identifiable package, the package 100 of the present invention also offers an ability to reduce costs related to manufacturing various product forms within a brand. For example, the product chamber 110 can be molded of a more rigid, more expensive plastic to hold the consumer care product 105 (FIG. 8) while the outer jacket 200 is molded of a less expensive material. Of course, the opposite may also be employed or materials of equal value may well be utilized for any and all layers of the package 100. A brand of products may be manufactured wherein the outer jacket 200 varies to identify the product 105 (FIG. 8) and the product chamber 110 is kept constant regardless of the product traits. Likewise, the design of the outer jacket 200 could be kept constant, while the outer surface 130 of the product chamber 110 varies. Without being bound by theory, a manufacturer may want to modify a product composition and promote such modification. There may be, however, consumers who will not want to embrace the change. Thus, a manufacturer faces a dilemma of pleasing loyal customers while wishing to promote the modification. Rather than pay excessive manufacturer costs often associated with such promotions, the present invention can provide a package 100 wherein the product chamber 110 remains constant as a holding vessel for the old and new composition and the outer jacket 200 varies between the old and new composition wherein the packages are easily and readily distinguishable. Consumers readily identify the new composition via its new package design and manufacturers readily identify the savings.

Voids Between the Product Chamber and the Outer Jacket

One or more voids may be defined between the product chamber and the outer jacket, or between each of these components and the optional inner sleeves. Exemplary voids 500 and 502 are shown in FIG. 5 and FIG. 7, respectively. The one or more voids may simply contain air, or may contain something more. For example, the void(s) may contain an identifier that is not associated with either the product chamber or the outer jacket, as is discussed above. The identifier can be in the form of a solid, a liquid, or both. By way of example only, the identifier can be a plurality of single or multiple colored beads; or a plurality of elements that employ a size, shape, or color that is intended to communicate a scent (e.g., discrete flower-shaped elements), level of strength, efficacy level or other product attribute to perspective buyers. The void(s) may also contain novelty or purely aesthetic items that consumers like or can relate to when choosing a consumer care product, but that do not necessarily communicate product attributes.

The one or more voids may alternately contain material that is intended to be accessed and used by consumers. For example, the void(s) may contain an air freshener product to freshen a bathroom environment where the product is stored, or may contain a personal care product such as a skin moisturizer or a breath mint.

It is to be understood that the present invention is not limited to component arrangements that give rise to one or more voids, and that the component configurations and dimensions may be such that substantially no voids exist upon assembling/manufacturing the components.

Exemplary Materials and Manufacturing Techniques

The material used for the product chamber, outer jacket, and closure of the package includes rigid and semi-rigid materials. For example, rigid and semi-rigid materials of the present invention may include, but are not limited to, metals, including but not limited to, aluminum, magnesium alloy, steel; glass; paperboard, including but not limited to, laminates and cardboards; and polymeric materials such as polypropylene (PP), polyethylene (PE), polystyrene (PS), polyethylene-terepthalate (PET), styrene-acrylonitrile copolymer (SAN), polyethylene-terepthalate copolymers, polycarbonate (PC), polyamides, acrylonitrile-butadiene-styrene (ABS) and mixtures thereof. Polymeric materials may also include various fillers known to the skilled artisan, such as, for example, mica, interference pigments, wood flour; or materials that are capable of “blooming” to the surface of a molded component. Whether making rigid or semi-rigid parts, the parts of the product chamber and outer jacket may be manufactured by any number of manufacturing methods known in the art including, but not limited to, injection molding.

The product chamber and outer jacket may be manufactured and subsequently assembled. Antiperspirants or other consumer care products may be charged into the product chamber before, after or during the assembly of the product chamber and the outer jacket.

Alternatively, the product chamber and outer jacket may be manufactured, such that the manufacturing process itself imparts at least some connectivity between the components. For example, the product chamber and outer jacket may be formed through a multi-shot molding process or an insert molding process. These molding processes may also be used for embodiments comprising one or more inner sleeves. The molding processes may employ the same or different materials to form the different components. For example, a polymeric material that results in a translucent or transparent part upon curing may be used for the outer jacket and a pigmented polymeric material used for the product chamber. Of course, the product chamber may also be translucent or transparent. The skilled artisan would readily appreciate that the individual components themselves may optionally be made from multiple materials and manufactured through known methods, such as, for example, multi-shot molding and insert molding.

As discussed above, the rigidity or flexibility may differ between the product chamber and outer jacket. A multi-shot process may be employed, for example, to form a relatively rigid product chamber and a relatively flexible outer jacket to impart tactile sensorial benefits. Elastomers or elastomer blends, for example, may be used to manufacture a relatively flexible outer jacket.

Due to the unique nature of the packaging of the present invention, the outer jacket may be offered to sale to consumers as a semi-permanent product, with filled product chambers separately offered for sale as part of a refill system. As refills, the filled product chambers may comprise conventional packaging aspects, or alternatively comprise minimal packaging aspects, such as, for example, a thin-gauged poly or metal film bag.

Different packaging components of the present invention may be made from different materials. In some preferred embodiments, packaging components that are in contact with and/or may come into with consumer care compositions are preferably made from virgin (or non-recycled) materials, while other packaging components can be made from virgin materials or recycled materials. By way of example only, a product chamber can be made from a material comprising virgin plastic, while the outer jacket and/or closure are made from a different material that may include recycled plastic and/or plastics comprising fillers known to the skilled artisan.

Method of Merchandising Consumer Care Products

The present invention also provides a method of merchandising a consumer care product by providing a package that directly communicates performance or product benefits and aids a consumer in the identification of their desired product without necessarily reading a label. As detailed above, such a package provides an advantageous means for distinguishing product form, scents, benefits and brands.

Referring generally to FIG. 8, a consumer care product 105 having a patterned appearance may combine with the package 100 of the present invention to create enhanced visual appeal that conveys performance benefits to a consumer. For example, a product 105 comprising a multi-phase composition wherein at least two colors are present may combine with the package 100 of the present invention to create an overall theme or scene. Consumers readily identify their product 105 (FIG. 8) by its identifiable multi-color, multi-phase composition that is enhanced by the aesthetically-pleasing and readily identifiable package 100 of the present invention.

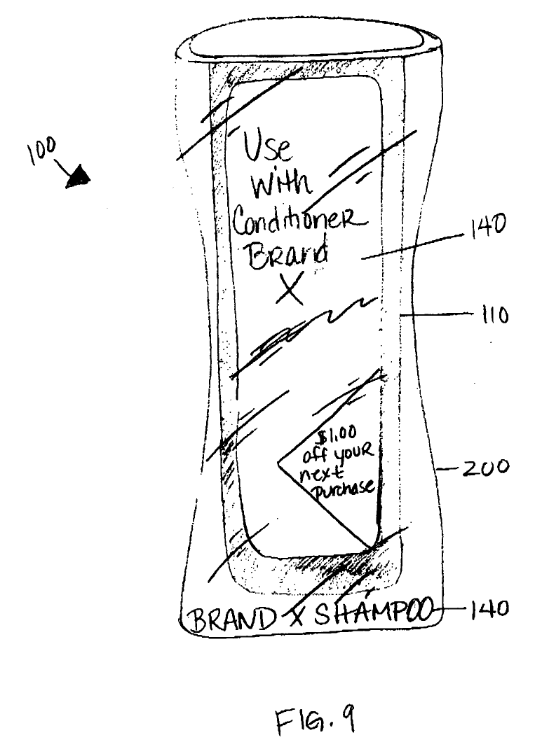

Referring generally to FIG. 9, the present invention may also relate to a method of promoting product purchases by using one or more layers to promote a complimentary product. For example, the package 100 of the present invention may communicate the benefits of the product 105 (FIG. 8) within and also advertise and promote to a consumer a complementary product that may enhance the performance characteristics of the product 105 (FIG. 8) within the package 100. Without being bound by theory, the package 100 of the present invention may comprise a hair care product such as a shampoo. While the outer jacket 200 may comprise an identifier 140 relating to the shampoo itself, the product chamber 110 may comprise an identifier 140 that promotes and advertises the complimentary conditioner. A consumer is thus directed to the appropriate conditioner that will provide enhanced benefits for use with the shampoo. While it may appear obvious to use a conditioner with a shampoo, a consumer is not left guessing which conditioner is appropriate for enhancing the performance and product benefits of the shampoo. Thus, in some forms, the present invention also relates to a method of advertising and a method of generating advertising revenues. For example, promotional advertising may be used such as “Buy 1, Get 1 Free” or “Save $1.00 on your next purchase”. The types of products promoted within the package of the present invention may vary and do not necessarily have to be complimentary to the product. Without being bound by theory, a promotional advertisement may include “Free can of coffee with this shampoo purchase” or “$1.00 off your next purchase of laundry detergent with this purchase of toothpaste”. Without being bound by theory, promotional contests may also be offered with the package of the present invention such as “Enter to win tickets to the Indy 500 with the purchase of this antiperspirant” or “A free chance to win NFL Superbowl tickets with the purchase of this after shave”.

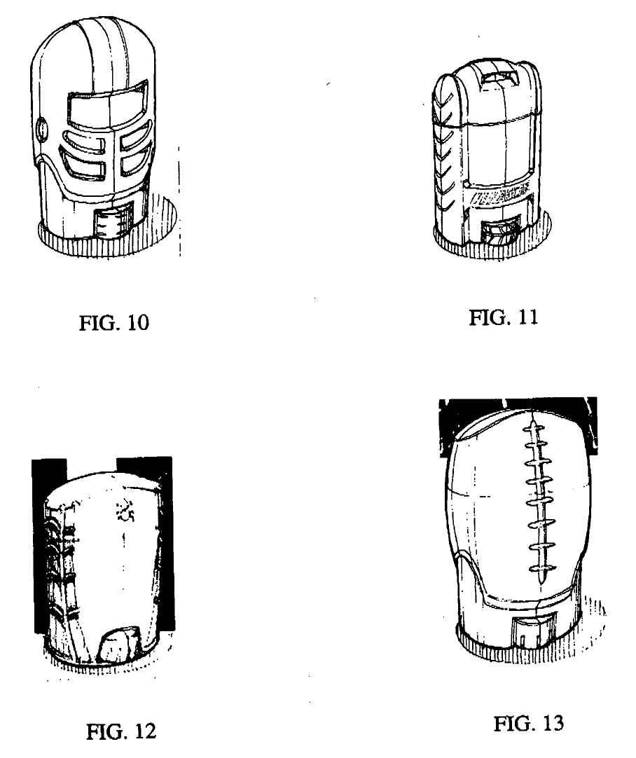

Such consumer care product may be displayed and merchandised in a retail store. As used herein, a retail store includes, but is not limited to, FDM (Food, Drug and Mass) markets, department stores, specialty stores, club markets and the like. Of particular interest may be FDM markets. Due to the distinctive elements of the present invention, however, there is no limit to the type of store or where in the store a product within the package of the present invention may be retailed. Products, therefore, may be retailed in regions of a store where similar products are not conventionally found. For example, skin care compositions may be retailed next to bottled water to promote enhanced skin care benefits. Or, for example, products may be packaged according to the present invention and retailed in stores where similar products are not conventionally found. As shown generally in FIGS. 10-13, antiperspirants/deodorants may be packaged accordingly and retailed in a non-conventional retail store for such a product. Such a non-conventional retail store for antiperspirants/deodorants, for example, may include a sporting goods store to aid a consumer in selecting a product comprising a particular efficacy that is beneficial while participating in a vigorous, athletic activity. Thus, the present invention provides novel features that facilitate convenience and aids a consumer with packages that are useful and distinct and further alleviate the shortcomings of currently marketed products.

### EXAMPLE 1

### Antiperspirant Composition

| Ingredient | Weight Percent |
|---|---|
| Cyclopentasiloxane | Quantity Sufficient |
| Aluminum Zirconium | 25.25 |
| Tetrachlorohydrate/gly powder | |
| Stearyl alcohol | 12.35 |
| PPG-14 butyl ether | 9.0 |
| Petrolatum | 5 |
| Talc | 2.5 |
| Hydrogenated castor oil | 2.75 |
| Ozokerite | 0.95 |
| Behenyl alcohol | 0.19 |
| Fragrance | 0.75 |
| Pigment^{a} | 1.0 |

^{a}Pearlescent Pigment Prestige 35322 Twinkling Silver (TiO₂ coated mica) commercially available from Eckart Cosmetics Colours of Louisville, KY.

The above exemplary composition may be contained within the various packaging embodiments described herein, including, but not limited to, those comprising transparent/translucent product chambers and/or outer jackets.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the term in a document incorporated herein by reference, the meaning or definition assigned to the term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A consumer care product, comprising:
a) packaging for the consumer care product comprising a product chamber at least partially surrounding the consumer care product; an outer jacket that is semi-permanently or permanently engaged with the product chamber, the outer jacket including a jacket outer surface; and a visibly detectable product identifier, wherein at least a portion of the identifier is not associated with the jacket outer surface; and
b) a consumer care composition disposed in the product chamber.

2. The consumer care product of claim 1, wherein the consumer care composition is an antiperspirant and/or deodorant composition.

3. The consumer care product of claim 1, wherein at least a portion of the outer jacket is translucent or transparent.

4. The consumer care product of claim 1, wherein at least a portion of each of the outer jacket and the product chamber is translucent or transparent so that the consumer care composition contained within the product chamber is visibly detectable.

5. The consumer care product of claim 1, wherein the packaging further comprises at least one void defined between the product chamber and the outer jacket.

6. The consumer care product of claim 5, wherein a second consumer care composition is disposed within the at least one void.

7. A consumer care product, comprising:
a) packaging that contains the consumer care product during use of the consumer care product, the packaging comprising an outer surface and a consumer care product identifier that is visibly detectable as viewed from outside the packaging, wherein the identifier is disposed radially inward from the outer surface; and
b) a consumer care composition disposed in the packaging.

8. The consumer care product of claim 7, wherein the consumer care composition is an antiperspirant and/or deodorant composition.

9. The consumer care product of claim 1, wherein at least a portion of the outer jacket is translucent or transparent.

10. A consumer care product, comprising:
a) packaging for the consumer care product comprising a product chamber at least partially surrounding the consumer care product; an outer jacket that is semi-permanently or permanently engaged with the product chamber, wherein the product chamber comprises a color and/or identifier associated with the brand of the consumer care product that is visibly discernable when viewing the packaging from the outside; and
b) a consumer care composition disposed in the product chamber.

11. The consumer care product of claim 10, wherein the product chamber is chromatic.

12. The consumer care product of claim 10, wherein the outer jacket is transparent or translucent, and wherein at least a portion of the product chamber comprises a color selected from the group consisting of red, pink, blue, and orange.

13. The consumer care product of claim 10, wherein the consumer care composition is an antiperspirant and/or deodorant composition.

14. An array of consumer care products, comprising:
a) a first consumer care product including a first brand and packaging comprising a first product chamber at least partially surrounding the first consumer care product, and a first outer jacket that is semi-permanently or permanently engaged with the first product chamber; and
b) a second consumer care product including the first brand and packaging comprising a second product chamber at least partially surrounding the second consumer product, and a second outer jacket that is semi-permanently or permanently engaged with the second product chamber,
wherein the first and second product chambers are visually distinct from one another.

15. The array of consumer care products according to claim 14, wherein the visual distinction between the first and second product chambers comprises differences in size, shape, color, and/or text or indicia associated therewith.

16. The array of consumer care products according to claim 14, wherein the first consumer care product and the second consumer care product have different product forms within a sub line of the first brand or across two or more sub lines of the first brand.

17. The array of consumer care products according to claim 16, wherein the first and second consumer care products are antiperspirants or deodorant products and the different product forms are selected from the group consisting of gels, solids, soft solids, aerosols, sticks, and roll-ons.

18. The array of consumer care products according to claim 14, wherein the first consumer care product and the second consumer care product have different product attributes available within a sub line of the first brand or across two or more sub lines of the first brand.

19. The array of consumer care products according to claim 18, wherein the different product attributes comprises different scents within the sub line of the first brand or across two more sub lines of the first brand.

20. The array of consumer care products according to claim 18, wherein the different product attributes comprises different levels of efficacy or strength within the sub line of the first brand or across two or more sub lines of the first brand.

21. An array of consumer care products, comprising:
a) a first consumer care product including a first brand and packaging comprising a first product chamber at least partially surrounding the first consumer care product, and a first outer jacket that is semi-permanently or permanently engaged with the first product chamber; and
b) a second consumer care product including the first brand and packaging comprising a second product chamber at least partially surrounding the second consumer product, and a second outer jacket that is semi-permanently or permanently engaged with the second product chamber,
wherein the first and second outer jackets are shaped differently.

22. The array of products according to claim 21, wherein the first and second product chambers are visually distinct from one another.

23. An array of consumer care products, comprising:
a) a first consumer care product including a first brand and a first packaging system comprising a first product chamber at least partially surrounding the first consumer care product; a first outer jacket semi-permanently or permanently engaged with the first product chamber, the first outer jacket comprising a first outer surface; and a first identifier that is disposed radially inward from the first outer surface; and
b) a second consumer care product including the first brand and a second packaging system comprising a second product chamber at least partially surrounding the second consumer product; a second outer jacket semi-permanently or permanently engaged with the second product chamber, the second a second outer surface, and a second identifier that is disposed radially inward from the second outer surface,
wherein the first identifier and the second identifier are different from one another.

24. An array of consumer care products, comprising:
a) a first sub line of consumer care products comprising a first packaging system and a first composition disposed therein, and a second packaging system and a second composition disposed therein, the second composition being different from the first composition, wherein each of the first and second packaging systems comprises a product chamber and an jacket semi-permanently or permanently engaged with the product chamber; and
b) a second sub line of consumer care products comprising a third packaging system and a third composition disposed therein, and a fourth packaging system and a fourth composition disposed therein, the fourth composition being different from the third composition, wherein each of the third and fourth packaging systems comprises a product chamber and an outer jacket semi-permanently or permanently engaged with the product chamber;
wherein at least one of the first, second, third and fourth packaging systems are visually distinct from another of the first, second, third and fourth packaging systems.

25. The array of products according to claim 24, wherein the outer jackets associated with the respective first, second, third and fourth packaging systems are visually distinct from one another.

26. The array of products according to claim 24, wherein the product chambers associated with the respective first, second, third and fourth packaging systems are substantially the same shape.

27. The array of products according to claim 26, wherein the product chambers associated with the respective first, second, third and fourth packaging systems are visually distinct from one another.

28. The array of products according to claim 24, wherein all of the first, second, third and fourth packaging systems are visually distinct from one another.

29. The array of products according to claim 24, wherein the outer jackets associated with the respective first and second packaging systems are shaped differently from the outer jackets associated with the third and fourth packaging systems.

30. The array of products according to claim 24, wherein the outer jackets associated with the respective first and third packaging systems are shaped differently from the outer jackets associated with the second and fourth packaging systems.

31. The array of products according to claim 24, wherein both of the first sub line of products and second sub line of products are marketed under the same brand name.

32. The array of products according to claim 24, wherein each of the first and second sub line of products is an antiperspirant or deodorant product.

33. The array of products according to claim 32, wherein the first and third compositions have a first product form and the second and fourth compositions have a second product form that is different than the first product form.

34. The array of products according to claim 33, wherein the first and second product forms are selected from the group consisting of roll-ons, solids, soft solids, and gels.

35. A packaging system for use with a consumer care product, the packaging system comprising a product chamber configured for at least partially surrounding a consumer care product, and an outer jacket that is semi-permanently or permanently engaged with the product chamber,
wherein the product chamber comprises a first material, and wherein at least a portion of the outer jacket comprises a second material that is different from the first material.

36. The packaging system of claim 35, wherein the first material is substantially devoid of recycled plastic, and wherein the second material comprises recycled plastic.

37. The packaging system of claim 35, wherein the first material is substantially devoid of recycled plastic, and wherein the second material comprises plastic that includes a filler.

38. The packaging system of claim 37, wherein the filler is selected from the group consisting of particles, fibers, air, and mixtures thereof.
